(19) United States
(12) Patent Application Publication
(10) Pub. No.: US 2013/0132113 A1
(43) Pub. Date: May 23, 2013

(54) METHOD AND SYSTEM FOR DISTRIBUTING COMMUNITY-BASED HEALTH SERVICE INFORMATION

(71) Applicants: Michael Elias Drobac, Washington, DC (US); Krista Donahue Drobac, Washington, DC (US)

(72) Inventors: Michael Elias Drobac, Washington, DC (US); Krista Donahue Drobac, Washington, DC (US)

(21) Appl. No.: 13/682,054

(22) Filed: Nov. 20, 2012

Related U.S. Application Data
(60) Provisional application No. 61/562,871, filed on Nov. 22, 2011.

(51) Int. Cl. G06Q 50/22

(52) U.S. Cl. CPC G06Q 50/22
USPC 705/2

(57) ABSTRACT

A method and system for distributing community-based health service information is provided. In one aspect, the method receives user information including a location and a health condition and determines a health issue that is related to the condition. Services are identified based on the health condition, the related health issue, and the user's location. The method also includes providing the user with the identified services.

### CROSS-REFERENCE TO RELATED APPLICATIONS

The present application claims the benefit of priority under 35 U.S.C. §119 from U.S. Provisional Patent Application Ser. No. 61/562,871 entitled “METHOD AND SYSTEM FOR DISTRIBUTING COMMUNITY-BASED HEALTH SERVICE INFORMATION,” filed on Nov. 22, 2011, the disclosure of which is hereby incorporated by reference in its entirety for all purposes.

### TECHNICAL FIELD

The present invention generally relates to the prevention, maintenance, and treatment of personal health issues and in particular to a method and system for distributing community-based health service information.

### SUMMARY

According to one embodiment of the disclosure, a method for distributing community-based health service information is provided. User information including a location and health condition is received and one or more health issues relating to the health condition are determined. The method additionally identifies a plurality of services for the user based on the health condition, the related health issue, and the location. The method further includes providing the plurality of services for display to the user.

According to another embodiment of the disclosure, a system for distributing community-based health service information is provided. The system includes a processor and a memory containing processor-executable instructions that, when executed by the processor, cause the system to maintain subscriptions of users and directory subscribers, as well as receive user referrals from a health care professional that include the location and health condition information of a user. The system is also caused to record the user referral of the health care professional and provide the recorded referral to a medical industry business. The system is further caused to provide for display of a service associated with the directory subscriber to the user, wherein the service is associated with the location and the health condition of the user.

Other features and advantages will be apparent from the following specification taken in conjunction with the following drawings.

### BRIEF DESCRIPTION OF THE DRAWINGS

To understand the present invention, it will now be described by way of example only, not by way of limitation, with reference to the accompanying drawings in which:

FIG. 1 is an exemplary architecture for distributing community-based health service information;

FIG. 2 is a block diagram illustrating an exemplary client and server from the architecture of FIG. 1 according to certain aspects of the disclosure;

FIG. 3 is an illustration of users of the community-based health service information distribution system, the system, and the flow of interaction;

FIG. 4 is a flow chart illustrating an exemplary process for distributing community-based health service information;

FIG. 5 is a flow chart further illustrating an exemplary process for distributing community-based health service information; and

FIG. 6 is a flow chart illustrating yet another exemplary process for distributing community-based health service information.

### DETAILED DESCRIPTION

While this invention is susceptible of embodiments in many different forms, there is shown in the drawings and will herein be described, examples of the invention with the understanding that the present disclosure is to be considered as an exemplification of the principles of the invention and is not intended to limit the broad aspect of the invention to the examples illustrated.

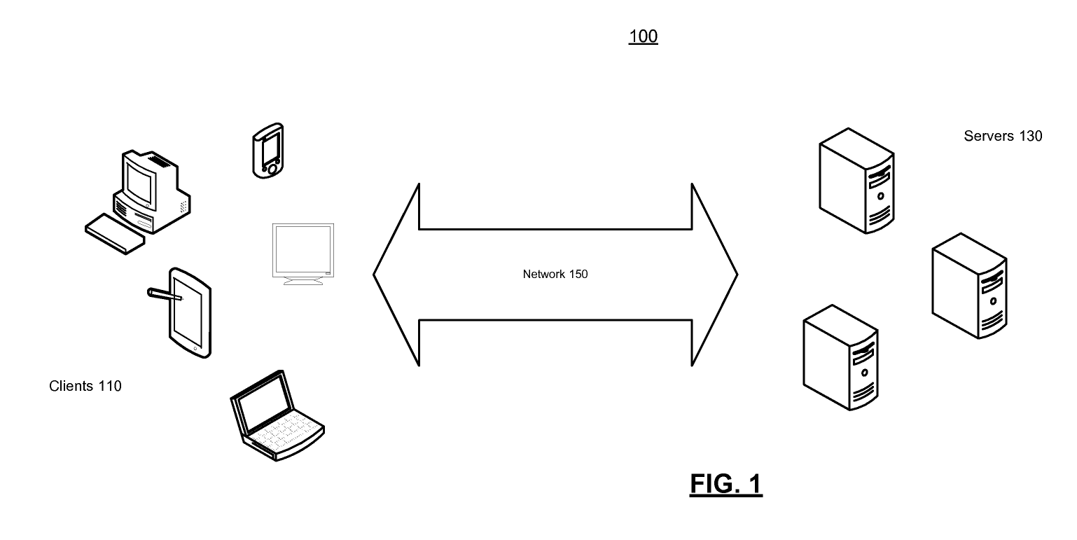

FIG. 1 illustrates an exemplary architecture 100 for distributing community-based health service information. In one embodiment, the architecture 100 includes servers 130, clients 110, and a network 150. Through clients 110, users, subscribers, health professionals, and medical industry, businesses may access and interact with the health and community services system or other associated web pages. Web applications specific to clients 110 may provide a specific interface for client devices.

Servers 130 can be any device having a processor, memory, and communications capability for distributing community-based health service information. The servers 130 host, update, and synthesize the user and subscriber information and additionally host other information related to other types of users. The health and community system may include additional features which further allow all types of users to interact, obtain statistics, or post information. The user profiles may also be linked to existing systems via servers 130 and network 150. Network 150 may include, but is not limited to, any one or more of a personal area network (PAN), a local area network (LAN), a wireless local area network (WLAN), a broadband network (BBN), the Internet, etc.

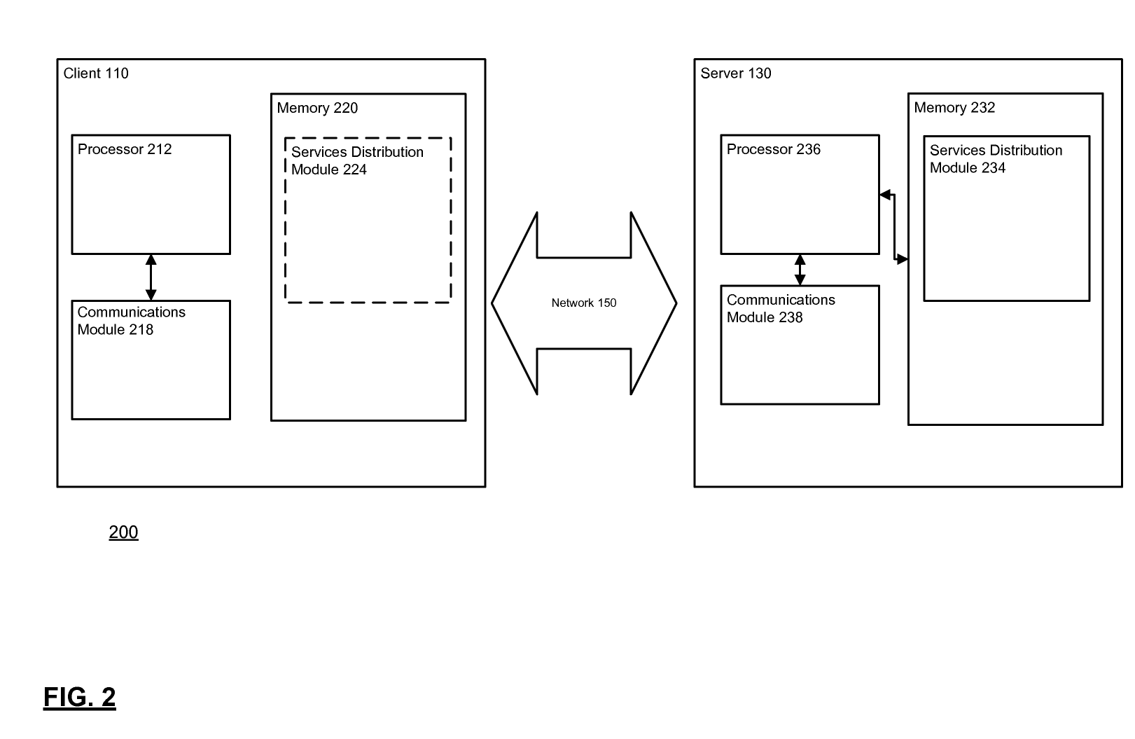

FIG. 2 is a block diagram illustrating an exemplary client and server from the architecture of FIG. 1 according to certain aspects of the disclosure. In one embodiment, client 110 includes processor 212, communications module 218 and memory 220. In another embodiment, memory 220 may further include a services distribution module 224 which may provide services of the health and community services system with limited connection to network 150. These services may be augmented, limited, or otherwise altered from those provided through network 150.

In one embodiment, server 130 includes processor 236, communications module 238, and memory 232 which has services distribution module 234 stored on it.

Communications modules 218 and 238 are configured to interface with the network of FIG. 1 to send and receive information including data, commands, requests, and responses to other devices on the network, and may comprise a modem or Ethernet card.

Processors 212 and 236 are hardware devices for executing software, particularly software stored in services distribution modules 224 and 234, respectively. The processors 212 and 236 can be any custom made or commercially available processor, a central processing unit (CPU), an auxiliary processor among several processors, a semiconductor based microprocessor (in the form of a microchip or chip set), a macroprocessor, or generally any device for executing software instructions.

Memories 220 and 232 can include any one or a combination of volatile memory elements, e.g. random access memory (RAM, such as DRAM, SRAM, SDRAM, etc.) and nonvolatile memory elements, e.g., ROM, hard drive, tape, CDROM, etc. Memories 220 and 232 may incorporate electronic, magnetic, optical, and/or other types of storage media. Memories 220 and 232 can have a distributed architecture where various components are situated remote from one another, but can be accessed by processors 212 and 236, respectively.

Although not shown, client 110 may additionally include input and/or output devices that allow a user to input information and receive information. For instance, input and/or output devices may include display screens, touch screens, microphones, video or still cameras, keyboards, mouse, speakers, printers, or any other device connected by universal serial bus (USB) port, other ports, or through a wireless connection.

It should be noted that executable computer programs, such as a method for distributing community-based health service information, can be stored on any computer readable medium for use by, or in connection with, any computer related system or method. In the context of the invention, a computer-readable medium can be any means that can store, communicate, propagate, or transport the program for use by or in connection with the instruction execution system, apparatus, or device. The computer readable medium can be, for example, but not limited to, an electronic, magnetic, optical, electromagnetic, infrared, or semiconductor system, apparatus, device, or propagation medium. A more specific, non-exhaustive list would include an electrical connection (electronic) having one or more wires, a portable computer diskette (magnetic), a RAM (electronic), a ROM (electronic), an erasable programmable read-only memory (EPROM, EEPROM, or Flash memory)(electronic), an optical fiber (optical), and a portable compact disc read-only memory (CDROM)(optical).

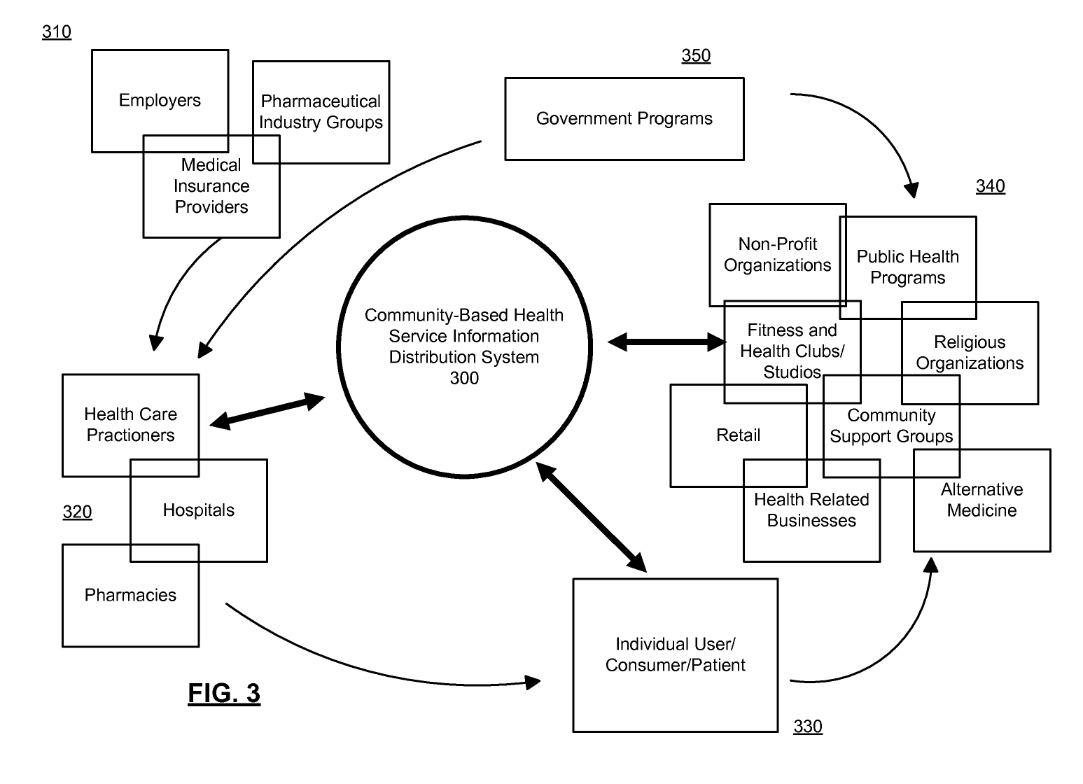

FIG. 3 is an illustration of users of the community based health service information system, the system, and the flow of interaction. Users of the system can be categorized into several different types of users, 310, 320, 330, 340, and 350 that interact with community-based health service information distribution system 300 (system 300).

User type 310 includes pharmaceutical industry groups, employers, and medical insurance providers. User type 310 may interact with system 300 by working with user type 320. For instance, a medical insurance provider of user type 310 may receive information from user type 320 regarding insured patients that are in user type 330. Alternatively, user type 310 may receive information regarding insured parties directly through system 300. Pharmaceutical industry groups, employers, and medical insurance providers may also receive anonymous statistical information directly through system 300.

User type 320 includes health care practitioners, hospitals, and pharmacists. Users of this type may constitute an individual health care practitioner such as a physician, psychologist, dermatologist, optometrist, or podiatrist. Alternative medicine practitioners and providers may also be members of user type 320. User type 320 may alternatively refer to a group of health care practitioners such as a specialized medical practice, an entire hospital, a clinic, an employer providing medical services to its employees, or a pharmacy. These users access system 300 primarily on behalf of individuals in user type 330 in conjunction with medical diagnosis or treatment. For instance, through system 300, a doctor may provide information and a list of services relating to the diagnosis of a health condition to the patient.

User type 330 includes, but is not limited to, individual users, consumers, and patients. These users primarily access the system 300 in order to obtain services and information regarding their own personal health. User type 330 also includes users accessing the system on behalf of another individual, such as a parent accessing information for a child, an assistant accessing information for a disabled or illiterate user, or a child who is caring for a parent. Individual users may independently interact with system 300 in search of community-based health service information or may be referred to system 300 from a doctor or other health care practitioner.

User type 340 may be called directory subscribers. This type of user includes retail businesses, fitness and health clubs and studios, non-profit organizations, for-profit organizations (not illustrated), businesses providing alternative medicines and medical practices, religious organizations, community support groups, groups of individuals (not illustrated), public health programs, and other health related businesses. User type 340 comprises the directory of community-based health services that are available to other users of system 300. User type 340 may provide or partially provide services directly through system 300. Alternatively, user type 340 may provide only information or registration capabilities to users for their services through system 300 while providing the actual service elsewhere. As another alternative, user type 340 may include advertisers whose advertisements are shown to other users through system 300. Advertisers may be limited to those users who are also directory subscribers. Advertisements may be individualized based on contextual information, the user's behavior, or user profile information. Charges for advertisements may be based on time, pay per click, or other methods of evaluating worth. Accordingly, advertisements relevant to the user's health conditions, user information, and registered services may be provided to the user.

Directory subscribers of user type 340 provide services, information, and/or products for individual users, consumers, and patients of user type 330. These services include, but are not limited to: weight loss programs; weight loss support groups; health and fitness programs; health and fitness classes; talk therapy or group meetings to address substance abuse or behavioral issues such as anger management; educational classes addressing nutrition, cooking, first aid, child safety, or stress management; acupuncture; services related to herbal remedies; chiropractic therapies; and services related to ayurvedic medicine. Additional services may be directed to the management, support, and/or prevention of chronic health problems such as diabetes, asthma, hypertension, arthritis, high cholesterol, fibromyalgia, and multiple sclerosis. Further, additional services may include religious support, meal delivery, transportation, medication adherence assistance, child care, life coaching, discount medical supply, prescription drug delivery, tobacco cessation programs, pre-natal support groups, or classes regarding breastfeeding, birthing, and parenting.

User type 340 may pay a fee for a listing and/or for an advertisement through system 300. User type 340 may be subject to a quality, reputation, or other assessment prior to or during the period of subscription to system 300.

A subscription for user type 340 to system 300 may include a general directory listing including contact information, services offered, cost, location, and reputation information. User type 340 offers services to consumers (user type 330) such as specific classes, programs, support groups, available treatment regimens, counseling, and information to the consumers. Directory subscriber information that is provided to the consumer may be categorized on the basis of directory subscriber name, location, service offered, date/time of classes or seminars, or the like. These categorized types of information may be determined by system 300 or may be provided and maintained by the directory subscriber. Alternatively or additionally, the categorized types of information may be obtained by system 300 through web crawling or other methods.

System 300 may serve as an interface through which a user type 330 may actually obtain the service. Further, system 300 may provide a means for registering a user of type 330 for one or more services through the system 300. For instance, the system 300 may provide the consumer with all available weight loss programs near the consumer's location. The system 300 may then allow a user to register for a weight loss program directly through the system. Registration may take the form of payment for a service, an appointment, a sign-up for a waitlist, a request for a consultation, an RSVP, a request for a representative of the directory subscriber to contact the consumer, or any other form of interaction between the consumer and directory subscriber that is facilitated through the system 300.

User type 350 includes government programs such as social insurance programs, government health programs, and other government programs focused on the prevention of disease, maintenance of chronic illness, and the general health of individuals. Although not indicated in the figure, user type 350 (and also user type 310) may interact with the System 300.

In addition to direct interaction with system 300, user types may have additional interaction with other user types indirectly. For example, government programs of user type 350 may provide incentives to other user types in order to promote prevention, maintenance, and treatment of health conditions of user type 330. User type 350 may achieve this by providing incentives for directory subscriber user type 340 to list their services through system 300. Additionally or alternatively, user type 350 may provide incentives for the number of users who obtain services with user type 340 through the system 300. Incentives may be financial, recognition based, service based, endorsement, or any other form of support. User type 350 may also interact with user type 320 (or user type 310) to provide incentives for health care practitioners and other users to refer members of user type 330 to system 300. For example, a doctor (user type 320), may receive incentives from government programs (user type 350) to refer a patient (user type 330) to system 300. The doctor may diagnose the patient, enter the patient's diagnosed health condition into system 300 and may provide his recommended course of treatment to the patient through system 300. The doctor may provide the available services to the user in any form of communication including, but not limited to, printed paper, email, telephone, in person, or directly to a user account of the patient on system 300.

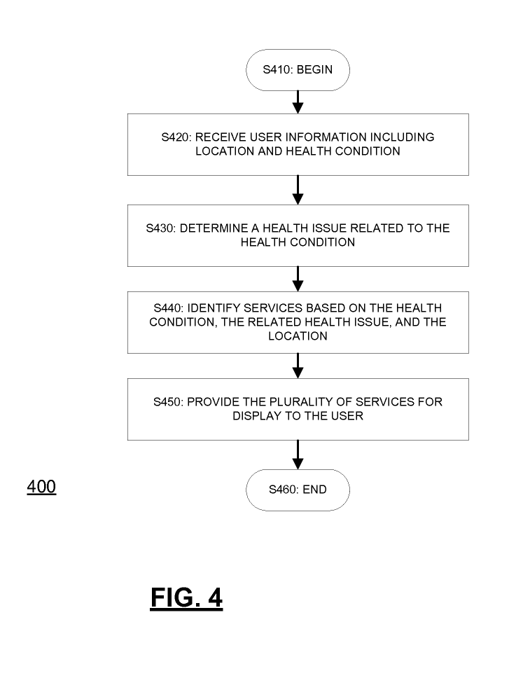

FIG. 4 is a flow chart illustrating an exemplary process for distributing community-based health service information. In one embodiment, the process 400 proceeds from Step 410 when a user such as an individual user, consumer, patient, or other user from user type 330 initially accesses the community-based health service information distribution system 300. The user may access the system 300 from any client 110.

In Step 420, the user will access or input information regarding location and a health condition. The user may initially sign up for the system and set default user information such as location, gender, age, weight, pre-existing health conditions, health issues, health concerns, other community-based health service information related inquiries, or statistical information that may be associated with a user profile or account. Multiple locations may be saved, and location information may consist of a zip code, address, city, state, region, intersection, or other location information. Location information also may include a range of search, such as “15 miles from home address.” Alternatively, geolocation may be provided by a navigation system, mobile device, or other similarly enabled client device 110. Upon subsequent uses, the user may access previously saved information, add information, or change information. Alternatively, a user may provide permission and access for a doctor, medical health care practitioner, directory subscriber, medical insurance provider, or other individual user to access the user's profile or account and enter information including, but not limited to, location and health condition. As yet another alternative, another user type, such as a doctor, may create a user profile and enter a health condition. This type of user profile may contain limited information regarding the user's location or other personal information. This user profile may be anonymous and identified by an account number or other anonymous identifier that a patient may later associate with a new or existing user profile or account. The anonymous user profile may additionally be updated or maintained to provide any desired level of privacy for the user.

Step 420 may further consist of a user accessing the user account and entering new user information or choosing from a selection of previously saved user information. For example, the user may specify one of several saved locations and one or more previously saved health conditions. While accessing the user account, the user may be provided with recommendations for services based on user information, previously obtained services, or previous searches.

In Step 430, services distribution module 224 or 234 determines one or more health issues related to the health condition. For instance, for the health condition “pregnancy,” related health issues may include pre-natal vitamins, breathing methods, birthing methods, newborn child safety, nutrition, birth complications, pregnancy complications, and the like. A health condition may be entered with more specificity such as “first trimester pregnancy” and may focus, filter, or limit the related health issues that are determined. By way of example only, a “first trimester pregnancy” health condition may be associated with health issues that are particularly pertinent such as nutrition, smoking cessation, pre-natal vitamins, morning sickness, and the like. In contrast, a “third trimester pregnancy” health condition may include related health issues focused on birth related topics such as post-partum depression, nutrition for newborns, and the like.

Related health issues may also include additional health conditions. For example, a health condition of “diabetes” may be associated with other health conditions such as kidney disease, heart disease, sleep apnea, or neuropathy. In this step, the user may be presented with a list of all health issues that have been associated with the health condition and may limit the issues presented at this step in the process. The user may additionally have the option of adding or removing health issues. User information may also be used in conjunction with the health condition to limit, augment, or focus the health issues that are associated to the health condition by the system. For instance, user information such as gender, age, weight, and other pre-existing conditions are examples of this additional user information. A user who has specified her gender as female and enters the health condition of “diabetes” in Step 420 may cause the system to associate health issues related to diabetes induced reproductive complications in Step 430. In Step 430, the user may be provided with a display of the health condition and related health issues that have been associated with the user entry. The user alternatively may not be notified of the health issues that have been related to the health condition during this step. The user may specify the number of issues shown at this step as a preference, or this information may be limited based on the type of client 110 that the user is acting through. For example, a mobile application may automatically limit the number of issues that are provided to the user for display.

Once health issues related to the health condition have been identified in Step 430, services provided by directory subscribers are identified and associated with the health condition and health issues in Step 440. The identified services are further limited by the location provided by the user, or the location associated with the user's account or profile. For example, a user who has specified the zip code 60613 may limit the identified services to services that are offered by a subscriber whose business is located in the zip code. Alternatively, classes that are offered by a subscriber may be provided in several different locations. The identified services may then be limited to the location of the class, rather than the location of the subscriber itself. Services that are offered directly through system 300 may be identified as located in the specified zip code. Alternatively, services offered through system 300, such as an online class, may be identified as located in the specified zip code if one other participant or the instructor of the class is located in the specified zip code. Services offered directly through system 300 may also be identified if the physical location of the directory subscriber is located in the specified zip code.

The user may also specify a range of location, such as “15 miles around zip code 60613.” Thus, services will be identified that are in the 15 mile radius surrounding the zip code. Variants of the location may be specified by the user, predetermined by the system 300, or a combination of the two.

The types of services identified are relevant to the identified health issues. For instance, if a related health issue of “weight loss” is determined, services such as diet programs, weight loss support groups, nutrition classes, exercise classes, and other services may be identified. For health issues such as “child safety” related to “third trimester pregnancy,” services such as CPR classes, classes on child-proofing the home, assistance for choosing infant car seats, and services providing in-home infant care may be identified.

Once services have been identified that pertain to the health condition, related health issues, and the user's location, the services are then provided for display to the user in Step 450. The display of services may include a list of services themselves, or a list of the directory subscribers providing the services. The identified services may be categorized for display by date of offered services (such as the starting date of a seminar), the location based on proximity, the reputation of the offered service, relevance to the user, price, or other criteria. The format of display may be set or changed by user preference, or may be limited based on the client 110 that is used for display or connectivity quality of network 150. Process 400 ends with Step 460.

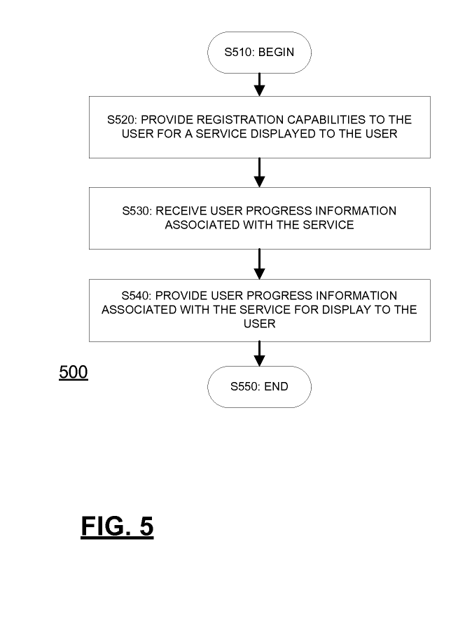

FIG. 5 is a flow chart illustrating an exemplary process 500 for distributing community-based health service information. Process 500 may begin following Step 460. Alternatively, the process may begin at Step 510 with a user logging into the user's account or profile, accessing previous results of process 400, an independent search inquiry, or information saved to or accessed through the user's account or profile.

In Step 520, the user accesses an identified service. Through system 300, the user is provided with the ability to register for the identified service. System 300, independent of the directory subscriber, may accept registration information and/or payment from the user for the service and later communicate the registration to the directory subscriber. Registration information and payment may be pre-provided based on user information in the user's account or profile, such as billing address, phone number, credit card number or other information authorized and provided by the user. The directory subscriber may pay the system 300 for this service, or alternatively charge a convenience fee to the user. Alternatively, the system 300 may provide a means to connect the user to the directory subscriber by providing a link, phone number, mailing address, fax number, or the like. The system 300 may support a ‘virtual store’ of a directory subscriber that allows the user to directly register with the directory subscriber through the interface of system 300.

Users may receive incentives to register or participate in the services provided by directory subscribers. For example, a user may receive a coupon, discount, rebate, or other incentive from the directory subscriber that is providing the service, from another directory subscriber, from an advertiser that is not a directory subscriber, from another user type (such as a medical insurance provider providing lower rates for those insured that are registering or participating in the services), and the like. Incentives may be presented or redeemed through the interface of system 300. Increased or additional incentives may be offered for continued participation in a service or for registering for multiple, related services.

Once registered for the service, the process proceeds to Step 530 in which user progress information is associated with the registered service. User progress information may include information indicating that the user has registered for a service and may include information regarding the fees paid, date registered, or other information. Progress information may additionally include the number of classes attended, the date of a service provided, attendance at a support group meeting, or other information related to the frequency of use of the service. Progress information may include substantive information about the user's performance in the class, activities that were undertaken during a class, “homework” assigned during the class, a contact list of members of a support group, weight loss measurements, calorie counts, blood pressure readings, or other measured information. Notes from an alternative medicine provider regarding the service rendered, products purchased from a retail provider, or other information may also constitute progress information. The user may also enter progress information directly into the system 300.

In Step 540, the user may access progress information associated with the service through the user's profile or account. The user may log into the user account to obtain a display of the user's progress information. The user may receive notifications when other user types have updated the user's progress information. The user may additionally receive notifications reminding the user to update the user account with new progress information. The user may set permissions in the user's account or profile to allow other users to obtain this information. For example, the user may provide a health care professional with access to view progress information (among other user information) so that the health care professional may monitor the user's health, prevention activities, maintenance of a chronic health condition, participation in support groups, user statistics such as weight or athletic achievements, or other information. The health care professional may be able to contact or interact with the user through system 300. Access may be given to another user or user type by identifying the other user's profile or account, by providing a specialized password, or by setting user preferences. User preferences may be set to allow specific others to view, edit, augment, delete, or otherwise access the user's progress information.

User preferences may also be set to allow users to interact with other users through system 300. The user may limit the information that is available to other users by type of user, by type of information, or by a specific health condition or health issue. Consenting users may be presented with recommended contacts, communities, or groups of users based on common locations, health conditions, or other user information. Communities or groups of users may be formed through system 300 by any user type or by the system itself. Users may share progress information, participate in classes together, or otherwise interact through system 300. System 300 may be integrated with one or more social networking sites to facilitate user interaction and accessibility. Process 500 ends at Step 550.

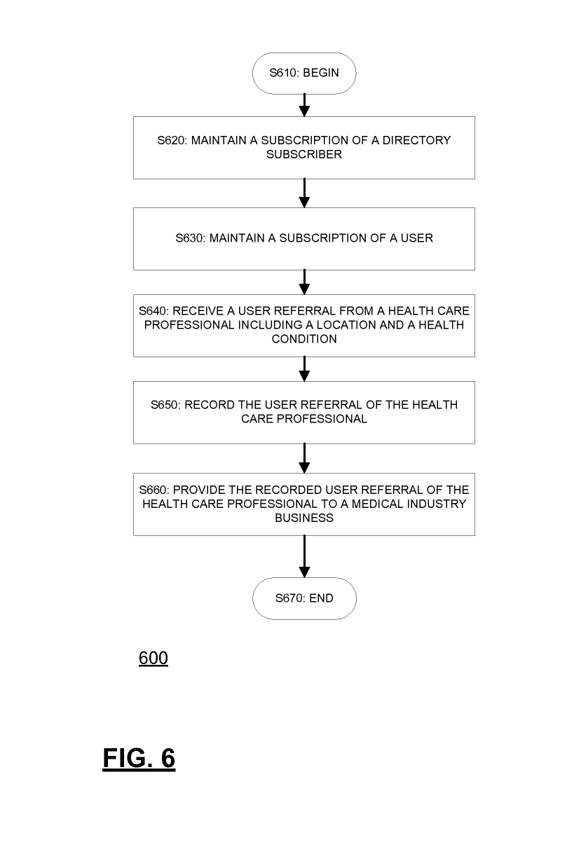

FIG. 6 is a flow chart illustrating yet another exemplary process for distributing community-based health service information. Process 600 begins with Step 610. In Step 620, the system 300 maintains a subscription of a directory subscriber. This step may be continuous throughout the remaining steps of process 600. Maintenance of a directory subscriber may include collecting payments to extend the directory subscription, regular updates of classes, calendars, locations, contact information, enrollment requirements, user progress information, information relating to advertisements, instructor biographies, and other information regarding the directory subscriber's business. Maintenance of a directory subscriber may also include regular auditing of the quality, reputation, licenses, qualifications, and other measures of the caliber of services provided.

Maintenance of a directory subscriber may further include initial registration of a directory subscriber. For example, during registration, a directory subscriber may be required to pay an initial flat fee, provide credentials, and provide other relevant information regarding locations, services offered, and the like.

In Step 630, the system 300 maintains a subscription of a user, such as an individual user of user type 330. Maintenance of an individual user may include collecting a re-occurring or one time subscription fee and/or collecting a re-occurring or one time fee for preferred user account status that may include advertisement free access to system 300 among other preferred user benefits. Maintenance of an individual user account may include updating of user information, location information, review of previously input information, review of user progress information, user preferences, user permissions, associated users, associated directory subscribers, and other user types that are associated with the user's profile or account, and the like.

In Step 640, a user (such as a patient) receives a referral from a health care professional (such as a doctor) including a location and a health condition. The user referral includes the doctor's use of the system 300 in conjunction with diagnosis. A user referral may include the use of process 400 to provide the patient with a selection of services pertaining to the doctor's diagnosis of a health condition. In this step, the doctor provides a diagnosis of a health condition to the patient. The doctor (or authorized representative of the doctor) may access the patient's user account on system 300 (if permission has been granted by the patient) and enter the patient's health condition and location. Location may be previously entered by the user and identified by virtue of the doctor's access to the user's account or profile. Process 400 may be performed in order to provide community-based health services information to the user. Alternatively, the doctor may create such a user referral by creating an anonymous profile or account as previously disclosed and enter health condition information and a location of the user. The anonymous profile may be provided to the patient, who may later associate the anonymous profile with the patient's existing profile. The patient may also populate the anonymous profile with user information to form the patient's user profile or account. Alternatively, the doctor may provide the patient with a physical print out of the identified services following process 400. A list of services may be provided digitally, through email, text message, or any type of electronic media. System 300 identifies each occasion in which the doctor creates a user referral. This identification may occur though a log-in process to the system where the doctor may have a user profile, identification number or other identifying data. Identification of a user referral may be anonymous with respect to the patient's identity and condition.

In Step 650, system 300 records the number of referrals provided by an individual health care professional, such as a doctor. The doctor may receive incentives based on the number of referrals performed through system 300. Incentives may be provided by user types 350 (government programs), 310 (medical insurance providers, employers, and pharmaceutical industry groups), or by system 300 itself. Incentives may be distributed on a personal, institutional, or company basis. For instance, user referrals made by a pharmacist may be attributed to the pharmacy at which the pharmacist is employed. The recorded number of referrals may be accessed by a user profile specific to users of user type 320.

In Step 660, the recorded user referral is provided to a medical industry business of user type 310. Access to this type of profile may be granted to users types 310 and 350 that provide incentives based on the frequency of referral or the total number of referrals. Recorded user referral may include de-identified information regarding the health conditions entered, or other de-identified information regarding patient information. Process 600 ends with Step 670.

While operations are depicted in the drawings in a particular order, this should not be understood as requiring that such operations be performed in the particular order shown or in sequential order, or that all illustrated operations be performed, to achieve desirable results. In certain circumstances, multitasking and parallel processing may be advantageous. Moreover, the separation of various system components in the aspects described above should not be understood as requiring such separation in all aspects, and it should be understood that the described program components and systems can generally be integrated together in a single software product or packaged into multiple software products.

While the foregoing has described what is considered to be the best mode and/or other examples, it is understood that various modifications may be made therein and that the subject matter disclosed herein may be implemented in various forms and examples, and that they may be applied in numerous other applications, combinations and environments, only some of which have been described herein. Those of ordinary skill in that art will recognize that the disclosed aspects may be altered or amended without departing from the true spirit and scope of the subject matter. As one example, the processes depicted in the accompanying figures do not necessarily require the particular order shown, or sequential order, to achieve desirable results. Therefore, the subject matter is not limited to the specific details, exhibits and illustrated examples in this description. It is intended to protect any and all modifications and variations that fall within the true scope of the advantageous concepts disclosed herein.

What is claimed is:

1. A method for distributing community-based health service information, the method comprising:
receiving user information including a location and a health condition;
determining a health issue related to the health condition;
identifying a plurality of services based on the health condition, the related health issue, and the location; and
providing the plurality of services for display to the user.

2. The method of claim 1, wherein at least one of the location information and the health condition information was previously saved by the user.

3. The method of claim 1, wherein at least one of the location information and the health condition information was previously saved by someone other than the user.

4. The method of claim 1, wherein the user information is obtained from an anonymous user profile.

5. The method of claim 1, wherein the location is the current geolocation obtained from a user device.

6. The method of claim 1, further comprising the steps of:
filtering a plurality of related health issues; and
using one or more of the plurality of related health issues that meet the filtering conditions for the identifying the plurality of services.

7. The method of claim 1, further comprising:
identifying a second health condition that is associated with the first health condition:
determining a health issue related to the second health condition;
identifying a plurality of services based on the second health condition, the related health issue, and the location; and
providing the plurality of services based on the first health condition and the second health condition for display to the user.

8. The method of claim 1, wherein the determining the health issue is based on further user information comprising at least one of gender, age, weight and pre-existing conditions.

9. The method of claim 1, further comprising:
categorizing the plurality of services based on at least one criteria; and
displaying one or more of the plurality of services in categorized order.

10. The method of claim 9, wherein the criteria comprises one of a date of offered services, a location based on proximity to the user, a reputation of the offered service, relevance to the user and price of the service.

11. The method of claim 1, further comprising the steps of:
providing a means of registering the user for service in the plurality of services;
receiving user progress information associated with the service; and
providing the user progress information associated with the service for display to the user.

12. The method of claim 11, further comprising providing the user progress information to someone other than the user.

13. The method of claim 12, wherein access to the user progress information by the person other than the user is provided by the user.

14. The method of claim 1, further comprising providing an incentive for the user to register for one of the plurality of services.

15. A system for distributing community-based health service information, the system comprising:
a processor; and
a memory containing processor-executable instructions that, when executed by the processor, cause the system to:
maintain a subscription of a directory subscriber;
maintain a subscription of a user;
receive a user referral from a health care professional including user information comprising a location and a health condition;
record the user referral of the health care professional; and
provide the recorded user referral of the health care professional to a medical industry business.

16. The system of claim 15, the instructions further causing the system to provide an incentive to the health care professional based on the user referral.

17. The system of claim 15, wherein the recorded user referral includes user information that is de-identified from the user.

18. The system of claim 15, the instructions further causing the system to provide a plurality of services based on the user referral.

19. A non-transitory machine-readable storage medium storing machine-executable instructions for causing a processor to perform a method for distributing community-based health service information, the method comprising:
receiving user information including a location and a health condition;
determining a health issue related to the health condition;
identifying a plurality of services based on the health condition, the related health issue, and the location; and
providing the plurality of services for display to the user.

20. The non-transitory machine-readable storage medium of claim 19, the method further comprising:
registering the user for service in one of the plurality of services;
receiving user progress information associated with the registered service; and
providing the user progress information associated with the registered service for display to the user.
